(19) United States
(12) Patent Application Publication
(10) Pub. No.: US 2007/0020033 A1
(43) Pub. Date: Jan. 25, 2007

(54) Scent emitting writing instrument

(76) Inventor: Daniel Walsh, Drakes Branch, VA (US)

Correspondence Address: Moss & Barnett P.A., 4800 Wells Fargo Center, 90 South Seventh Street, Minneapolis, MN, 55402-4129, US

(21) Appl. No.: 11/450,501

(22) Filed: Jun. 9, 2006

Related U.S. Application Data
(60) Provisional application No. 60/688,876, filed on Jun. 9, 2005.

(51) Int. Cl. B43K 29/00

(52) U.S. Cl. 401/195

(57) ABSTRACT

A writing instrument having a writing cartridge disposed in a housing or barrel. A scent emitting material is replaceably disposed on/or to the writing instrument to emit a pleasant smell or odor. In an example embodiment, the scent emitting material comprises a substrate such as a roll of paper disposed in the housing. A scented cartridge can also be disposed on/or to the writing instrument to emit a pleasant smell or odor. The scented cartridge and/or substrate are replaceable with other scented cartridges and substrates, thereby enabling a user to choose their desired scent.

### BACKGROUND OF THE INVENTION

1. Field of the Invention

The present invention relates to writing instruments and more particularly to a writing instrument that emits a scent.

2. Description of the Prior Art

Writing instruments that emit a scent are known in the art. These instruments have typically utilized cylindrical housings or barrels adapted to absorb a liquid that evaporates and thereby emits a scent. Other instruments utilize a modified cap or cover that acts as a container for holding a material that emits an odor. Still other instruments have compartments for storing a liquid such as a perfume that can be sprayed into an environment proximate the user. All of these writing instruments are difficult to use and can create a mess if the compartment becomes compromised.

### SUMMARY OF THE INVENTION

The invention is a writing instrument having a writing cartridge disposed in a housing or barrel that can be griped by a user during use. A scent emitting material is replaceably disposed on/or to the writing instrument to emit a pleasant smell or odor. In an example embodiment, the scent emitting material comprises a substrate such as a roll of paper disposed in the housing of the writing instrument. The scented substrate can have multiple perforations that permit it to be separated from the roll and used for taking notes.

A scented cartridge is disposed on/or to the writing instrument to emit a pleasant smell or odor. The scented cartridge can comprise a nose cone impregnated with a scent. The nose cone is removably insertable into a nose cap or cover that is used to cover the writing cartridge. The cover has at least one hole or aperture extending therethrough to permit the scent to escape into an environment proximate the user. The scented nose cone and/or substrate are replaceable with other scented nose cones and substrates, thereby enabling a user to choose their desired scent.

An object of the invention is to provide a scented writing instrument that is easily manufactured and used.

Another objection of the invention is to provide a scented cartridge that is easily inserted into and removed from the nose cap.

Still another object of the invention is that it eliminates the need of a user to search for a piece of paper on which to take notes.

Still yet another advantage of the invention is that it provides a scented writing instrument that is easily refillable.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded view of a scent emitting writing instrument according to an example embodiment of the present invention.

FIG. 2A is a perspective view of a housing according to an example embodiment of the present invention.

FIG. 2B is a cross section view of the housing according to an example embodiment of the present invention.

FIG. 2C is an end view of the housing according to an example embodiment of the present invention.

FIG. 2 is an enlarged exploded view of a cover according to an example embodiment of the present invention.

FIG. 3 is a plan view of a lancet coupler according to an example embodiment of the present invention.

FIG. 4 is a cross section view of the cover according to an example embodiment of the present invention.

FIG. 5A is a perspective view of a nose cone according to an example embodiment of the present invention.

FIG. 5B is a cross section view of the nose cone according to an example embodiment of the present invention.

FIG. 5C is an end view of the nose cone according to an example embodiment of the present invention.

FIG. 6A is a perspective view of a nose cap according to an example embodiment of the present invention.

FIG. 6B is a cross section view of the nose cap according to an example embodiment of the present invention.

FIG. 6C is an end view of the nose cap according to an example embodiment of the present invention.

FIG. 6D is a perspective view of the end of the nose cap according to an example embodiment of the present invention.

FIG. 7A is an exploded perspective view of an end cap assembly according to an example embodiment of the present invention.

FIG. 7B is a cross section view of an outer end cap according to an example embodiment of the present invention.

FIG. 7C is an end view of the outer end cap according to an example embodiment of the present invention.

FIG. 7D is a cross section of an inner end cap according to an example embodiment of the present invention.

FIG. 7E is an end view of the inner end cap according to an example embodiment of the present invention.

The preceding description of the drawings is provided for example purposes only and should not be considered limiting. The following detailed description is provided for more detailed examples of the present invention. Other embodiments not disclosed or directly discussed are also considered to be within the scope and spirit of the present invention.

### DESCRIPTION OF THE PREFERRED EMBODIMENT

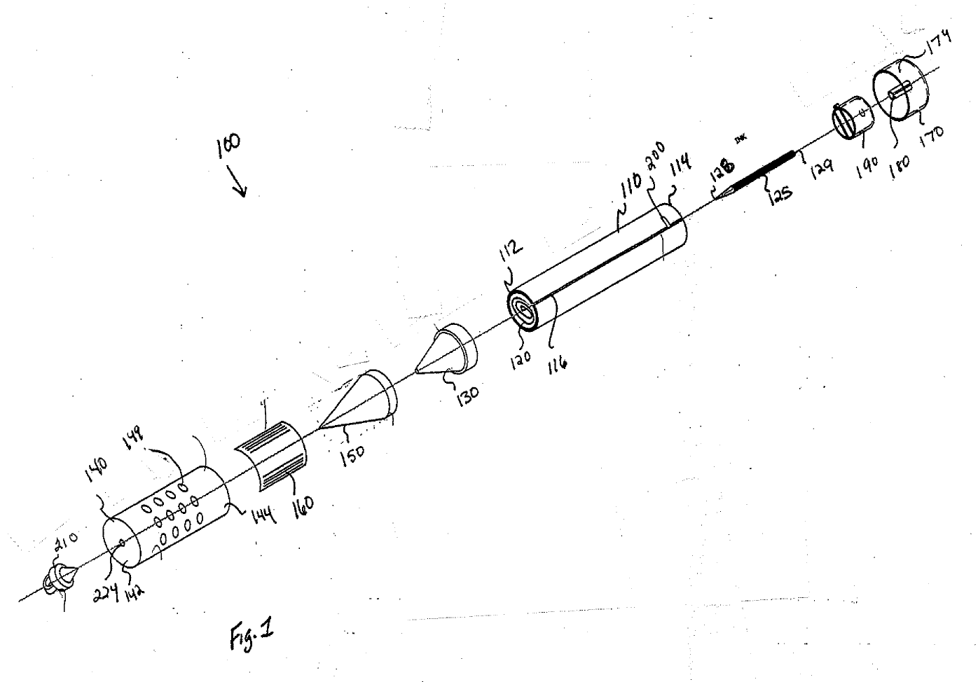

Referring to FIGS. 1-7E, a scent emitting writing instrument such as a pen, ballpoint pen, fountain pen, pencil, marker, highlighter and the like, is indicated by the number 100. Writing instrument 100 includes a housing, barrel, or pen tube 110 having an open first end 112 and an open second end 114 in registration with each other along a longitudinal axis thereof.

Housing 110 can be manufactured from any material that is currently used in the manufacturing of writing instruments such as metal, wood, polypropylene or other plastic materials. Housing 110 can be manufactured with any color, design or lettering printed on its outer surface for advertising of a particular trademark, logo, or brand. This is of particular importance if the writing instrument is utilized as a marketing tool since vivid colors, designs and lettering typically attract a user's eyes and others toward the writing instrument.

To ensure that housing 110 is comfortable to use it may have a generally cylindrical shape. However, housing 110 may have any cross sectional shape such as, for example triangular, square, oval, and the like. An outer surface of housing 110 may be coated and/or ribbed to increase tactile feel and improve comfort. A compressible sleeve (not shown) can be slid over housing 110 to provide additional comfort for a user.

A scent emitting materials is disposed on/or to writing instrument 100. The scent emitting material can be impregnated with a desired scent by any means including soaking the material in a chemical having a particularly desireable scent. The material can also be manufactured from a material inherently having a desirable scent. Other methods of imparting a scent to a material is also contemplated and should be considered to be within the spirit and scope of the invention.

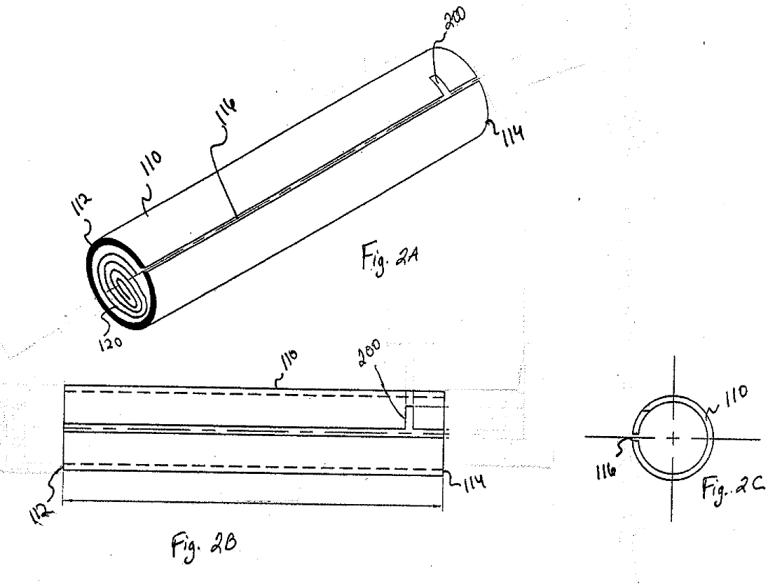

In on example embodiment of the invention, the scented material comprises a substrate 120 such as paper disposed in housing 110. Referring to FIGS. 2A-2C, housing 110 includes an elongate slit 116 extending generally along a length thereof for permitting a user to dispense substrate 120. In this embodiment substrate 120 is arranged as a roll of paper. Other configurations are also possible and should be considered to be within the spirit and scope of the invention.

If substrate 120 is arranged as a continuous roll of paper, edges of housing 110 defining elongate slit 116 can have generally serrated edges to serrate substrate 120 into a desired length. In another example embodiment of the invention, substrate 120 can have spaced perforations (not shown) extending therethrough for permitting easier separation of individual sheet from the roll.

Substrate 120 can include a generally tacky portion or section on its rear or back surface for permitting at least temporary adhesion to a surface. The adhesive may be disposed adjacent to at least one or both of the perforations. Substrate 120 can also be manufactured having the adhesive cover its entire rear or back surface for complete adhesion to a surface.

Substrate 120 can be impregnated, by soaking in a chemical or like substance to impart it with a scent that can be emitted through the slit 116 and/or when substrate 120 is dispensed. Any desired scent can be used. A user can also easily change substrate 120 rolls depending upon the scent they desire for that day or time.

Substrate 120 can be dyed a color corresponding to the scent that it emits for example pink for watermelon, orange for orange, and red for apples. Other color and scent combinations can also be used and are considered to be within the spirit and scope of the invention.

Referring back to FIG. 1, an ink, led, marker or similar cartridge 125 is removably disposed within housing 110. Cartridge 125 is disposable through a center of substrate 120 and housing 110. Cartridge 125 has a first writing end 128 that is disposed proximate first end opening 112 of housing 110 and second securing end 129 proximate second end opening 114 of housing 110. Cartridge 125 can dispense scented or non-scented ink, lead, and like matter.

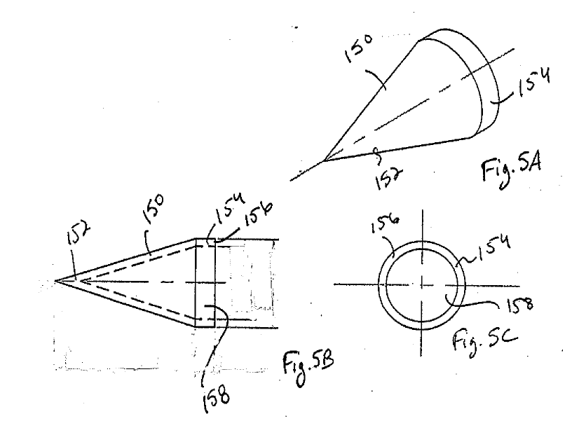

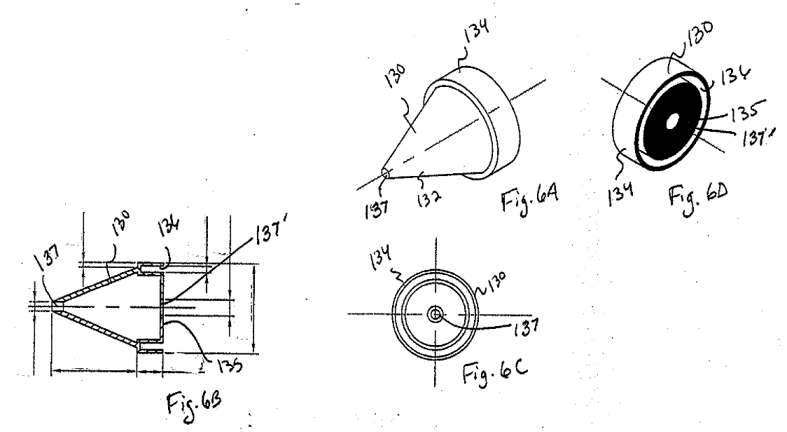

A nose cap 130 can be removably disposed over first end opening 112 of housing 110 to provide support to cartridge 125. Referring particularly to FIGS. 1 and 6A-6D, nose cap 130 is comprised of a generally conical housing having a generally conical tip portion 132 and a generally annular collar portion 134 having an outer diameter generally greater than an outer diameter of tip portion 132. As particularly illustrated in FIGS. 6B-6D, nose cap 130 has a lower or bottom wall 135 for supporting substrate 120 when disposed on housing 110. An annular channel 136 extends into annular collar portion 134 and about bottom wall 135 for receiving first end opening 112 of housing 110. In one example embodiment, nose cap 130 can be threadedly coupled to housing 110. In another example embodiment, nose cap 130 can be pressure fitted to housing 110. When nose cap 130 is disposed on housing 110 first writing end 128 of cartridge 125 extends through holes 140 and 140′ extending through tip portion 132 and bottom wall 135 respectively.

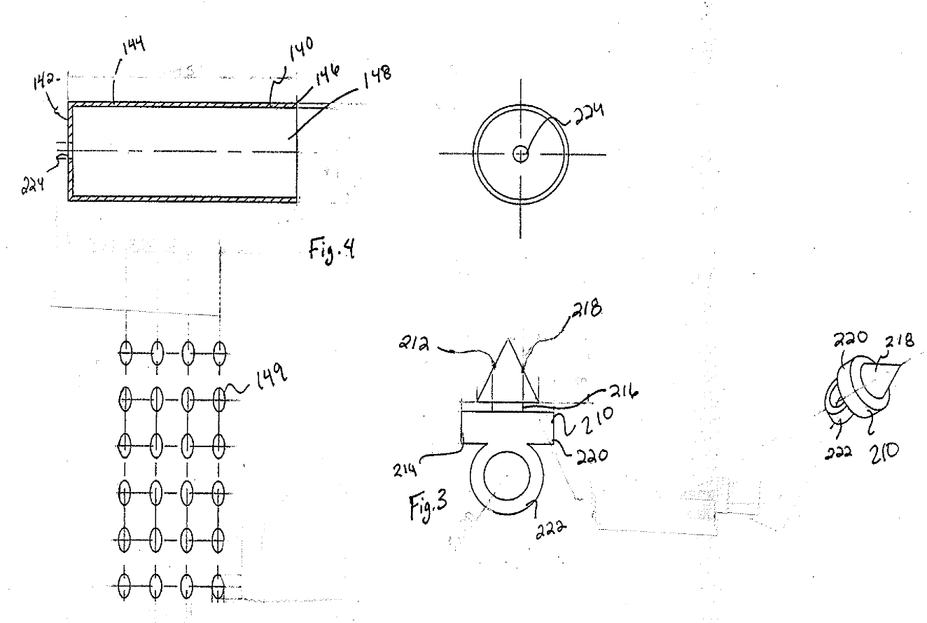

Referring to FIGS. 1 and 4, a nose cap cover 140 can be provided to prevent first writing end 128 of cartridge 125 from drying out or becoming dull. Nose cap cover 140 has a top or upper wall 142 and a peripheral wall 144 extending away therefrom. Peripheral wall 144 has an edge 146 defining an access opening 148 for receiving nose cap 130. Peripheral wall 144 of nose cap cover 140 can extend and partially cover elongate slit 116 of housing 110 to prevent unintended dispensing of substrate 120.

Turning to FIGS. 1 and 5A-5C, a scented cartridge 150 can be disposed generally between nose cap 130 and nose cap cover 140 to emit a scent. Scented cartridge 150 can be used in addition to or in lieu of scented substrate 120. In one example embodiment, scented cartridge 150 comprises a matter or material formed into a cone having a tip portion 152 and a collar portion 154. Collar portion 154 of scented cartridge 150 has a free edge 156 defining an opening 158 for receiving nose cap 130.

In one example embodiment of the invention, scented cartridge 150 has a size and shape adapted to fit relatively securely in access opening 148 of nose cap cover 140. To facilitate the coupling, collar portion 154 of scented cartridge 150 can have an outer diameter slight greater than an inner diameter of peripheral wall 144 of nose cap cover 140 thereby causing friction engagement between the two upon insertion of scented cartridge 150 into nose cap cover 140.

Referring to back to FIG. 1, nose cap cover 140 can have at least hole 149 extending therethrough for permitting the scent of scent cartridge to escape into an environment proximate a user. As particularly illustrated in FIG. 1, multiple holes 149 can extend through peripheral wall 144 of nose cap cover 140.

A cover or sheet 160 such as paper can be temporarily adhered over hole or holes 149 of nose cap cover 140 to prevent the scent from escaping during transit. When a user purchases writing instrument 100 he or she can simply pull cover 160 off of nose cap cover 140 to permit the scent to escape. Cover 160 can be coated with a material such as wax, plastic, and like substances to aid in preventing the scent from escaping.

In one embodiment, cover 160 comprises a flap having at least one edge that is permanently attached to nose cap cover 140. A user can flip cover 160 to expose hole or holes 149. In this embodiment, cover 160 can comprise a resiliently flexible material such as a formed rubber or like material

In another embodiment, cover 160 comprises a generally rigid plate that is slidably mounted or coupled to nose cap cover 140. Rotation or sliding of cover 160 in this embodiment exposes hole or holes 149 and permits the scent to escape. Cover 160 can be slid in either parallel or transverse to a longitudinal axis of nose cap cover 140. Cover 160 can be manufactured with either side or top and bottom rails that are slidably disposed in corresponding tracks of the nose cape cover 140.

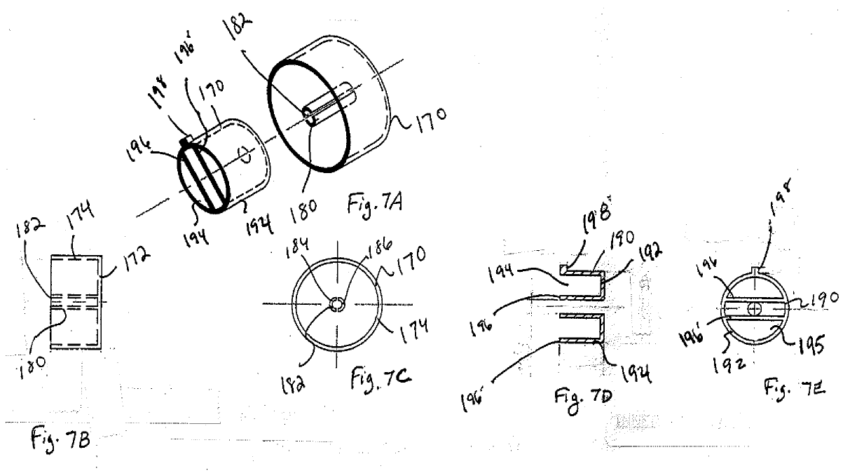

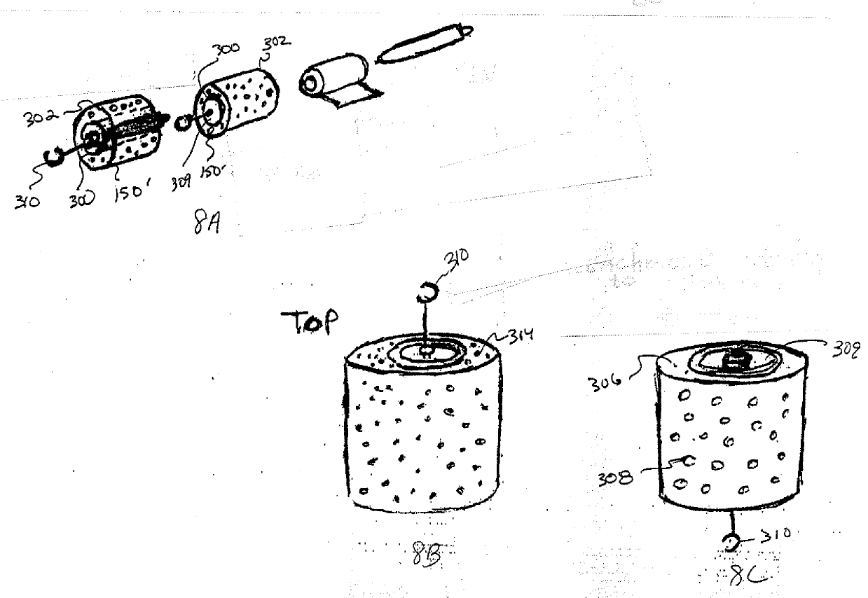

Referring to FIGS. 1 and 7A-7E, at least one end cap 170 is detachably couplable to the second end opening 114 of housing 110 for holding the second end 129 of cartridge 125. In one embodiment, end cap 170 comprises a top wall 172 having a peripheral wall 174 extending away therefrom that defines an access opening 176 for receiving second end opening 114 of housing 110.

End cap 170 includes a post 180 having a bore 182 extending longitudinally therein for receiving and at least temporarily securing cartridge 125. Post 180 extends from an inner surface of top wall 172 and is centrally disposed therein. In another example embodiment, as particularly illustrated in FIG. 7C, post 180 is divided along its longitudinal axis defining first 184 and second 186 post portions that extend away from each other when cartridge 125 is inserted in bore 182. In this embodiment, an inner diameter of bore 182 is at least slightly smaller than an outer diameter of cartridge 125 to create a friction fit therebetween.

In another example embodiment, as illustrated in FIGS. 1, 7A and 7D-7E, an attachment member 190 is operatively coupled between housing 110 and end cap 170 to secure end cap 170 to housing 110. In an example embodiment, attachment member 190 has a top wall 192 and a peripheral wall 194 extending away therefrom forming an interior space 195. A pair of supports 196 and 196′ can be disposed in and extend generally across the interior space 194. Supports 196 and 196′ can comprise plates or panels having a length generally equal to a length of peripheral wall 194.

Top wall 192 of attachment member 190 has a generally centrally disposed aperture 196 extending therethrough for receiving post 180. In an example embodiment, post 180 is disposed generally between supports 196 and 196′. Attachment member 190 can be secured in end cap 170 by an adhesive or other mechanical means such as by threaded engagement.

Attachment member 190 can also include a tab 198 extending away from an outer surface of its peripheral wall 174 for operatively engaging and securing end cap 170 to housing 110. In an example embodiment, as illustrated in FIGS. 1 and 2A-2B, tab 198 operatively engages slit 116 and a notch 200 extending transversely therefrom into housing 110. To secure end cap 170 to housing 110 tab 198 is inserted and slid within slot 116. As second end opening 114 of housing 110 confronts an inner surface of the top wall 172 of end cap 170, tab 198 becomes aligned with notch 200. Rotation of end cap 170 forces tab 198 into notch 200 such that it extends transversely through notch 200 thereby preventing its disengagement from housing 110. Other means of engaging end cap 170 to housing 110 are also contemplated by the invention, for example threaded engagement, pressure fitting, and snap fitting.

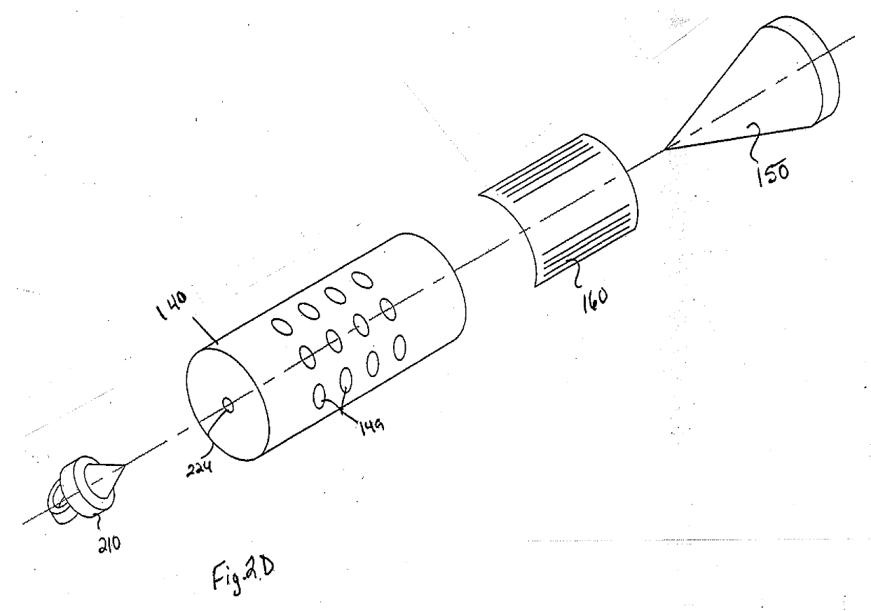

A coupling member 210 such as an eyelet, loop, hook, strap, tether, and similar devices can be coupled to writing instrument 100. In an example embodiment, as illustrated in FIGS. 1 and 3, coupling member 210 comprises an eyelet having plug portion 212 joined to and extending from an anchoring portion 214. Plug portion 212 is adapted for operative engagement with writing instrument 100.

In an example embodiment, plug portion 212 can include a conical section 216 disposed on an end of a shaft section 218 that is centrally disposed on anchor portion 214. Conical section 216 is adapted for operative engagement with a hole 224 extending into nose cap cover 140. Hole 214 can extend through top wall 142 of nose cap cover 140 such that writing instrument vertically hangs when attachment member 210 is coupled to a tether, keychain, necklace, or similar device.

Anchor portion 214 can include a base section 220 and an attachment section 222. The shaft section 218 is disposed on an upper surface of base section 220 while the attachment section 222 is disposed on a lower surface of base section 222. In on example embodiment, attachment section 222 comprises a loop that is adapted to receive a tether or similar device. Attachment member 210 can comprise any compressible material such as rubber, plastic and the like.

After purchase, a user removes cover 160 thereby exposing hole or holes 149 and permitting the scent absorbed or impregnated in scent cartridge 150 to escape. Nose cap cover 140 is easily removed or disengaged from housing 110 thereby exposing cartridge 125 for writing. When a substrate is not available a user may pull on substrate 120 disposed in housing 110. A user can pull substrate 120 through slit 116 in housing 110. A piece or section of substrate 120 can be removed by utilizing serrated edges defining slit 116 if present, or by tearing along one or more perforations formed in substrate 120. After writing on substrate 120 a user can the adhesive back to stick it on a vertical or generally vertical surface.

In one example embodiment, substrate 120 is impregnated with a scent that is emitted when it is removed from housing 110. In another example embodiment of the invention, nose cap 130 can include at least one hole extending therethrough to permit the scent of substrate 120 to flow into nose cap cover 140 and out hole or holes 149. Scent cartridge 150 may or may not be used when scented substrate 150 is utilized. If scent cartridge 150 is utilized in conjunction with scented substrate 150 the scents can mix and flow out through hole or holes 149.

Substrate 120 can be easily replaced by rotating end cap 170 such that tab 198 operatively disengages from notch 200. Once disengaged, a user pulls on end 170 causing tab 198 to travel along slit 116 until it is free. New substrate 120 can then be inserted into housing 110. A portion of substrate 110 can be left extending through slit 116 to facilitate easier access to it. End cap 170 can then be replaced by reversing the above steps. Writing cartridge 125 can also be replaced when end cap 170 is free from housing 110.

Scent cartridge 150, which can comprise a solid, gel or the like, is easily replaceable by removing nose cap cover 140. Once nose cap cover 140 is removed or disengaged from housing 110, a user can insert their finger or other object into scent cartridge 150 and pull it from nose cap cover 140. Other methods of replacing or changing scent cartridge 150 are also considered to be within the spirit and scope of the invention.

Numerous modifications are also contemplated in the present invention. For example, all parts of writing instrument 100 can be manufactured from a single material such as wood, metal or plastic. All parts of writing instrument 100 can also comprise any combination, without any limitation, of the above materials. Advertising, logos, designs and other indicia can be imprinted or imparted on any component of writing instrument 100 including, but not limited to, housing 110, nose cap 130, cover 160, nose cap cover 140, and/or end cap 170.

The present invention may be embodied in these and other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A scent emitting writing instrument comprising:
a housing having an interior;
a scent emitting material operatively coupled to the housing to emit a scent; and
a writing cartridge operatively disposed to a portion of the housing.

2. The scent emitting writing instrument of claim 1, wherein the scent emitting material comprises a substrate operatively dispensable from an interior of the housing, wherein a user can write upon the substrate with the writing cartridge.

3. The scent emitting writing instrument of claim 1, further comprising an adhesive being disposed over at least a portion of the substrate such that the adhesive prevents the substrate from coiling.

4. The scent emitting writing instrument of claim 1, further comprising a cover that removably encloses the writing cartridge, wherein the scented emitting material is enclosed in a cartridge disposed between the cover and the writing cartridge to emit a scent and support the writing cartridge.

5. The scent emitting writing instrument of claim 4, wherein the scent emitting cartridge has a shape adapted to receive the writing cartridge.

6. The scent emitting writing instrument of claim 4, wherein the scent emitting cartridge contains scent crystals capable of emitting a scent.

7. The scent emitting writing instrument of claim 4, wherein the cover includes at least one hole extending therethrough to permit fluid communication between the scent emitting material in the scent cartridge and an outside environment.

8. The scent emitting writing instrument of claim 4, wherein the scent emitting cartridge comprises inner and outer spaced apart walls, and top and bottom spaced apart walls to define an interior, at least the outer wall includes at least one hole extending therethrough for permitting fluid communication between the scent emitting material in the scent cartridge and an outside environment.

9. The scent emitting writing instrument of claim 8, further comprising an access to the interior of the scent cartridge, whereby a user can fill the scent cartridge.

10. The scent emitting writing instrument of claim 2, wherein the housing includes a elongated slit extending along at least a portion of its axis to permit the substrate to extend out from an interior of the housing.

11. A scent emitting writing instrument comprising:
an elongate housing, a substrate being operatively coupled to the housing;
a writing cartridge removably disposed in and extendable from the housing to permit a user to write;
a scent cartridge having a bore extending therein to receive the housing, the substrate and the writing cartridge; and
a scent emitting material being disposed in the scent cartridge.

12. The scent emitting writing instrument of claim 11, wherein the substrate is impregnated with a scent.

13. The scent emitting writing instrument of claim 12, wherein the substrate has a rear surface having an adhesive disposed over at least a portion thereof that permits it the substrate to removably stick to a surface without coiling.

14. The scent emitting writing instrument of claim 11, wherein the ink comprises a scent emitting material such that a scent is emitted from any writing.

15. The scent emitting writing instrument of claim 11, further comprising a cover for receiving the scent cartridge, housing, substrate and ink cartridge.

16. The scent emitting writing instrument of claim 15, wherein the cover has at least one hole extending therethrough to permit a scent to flow from the scent material in the scent cartridge.

17. The scent emitting writing instrument of claim 16, further comprising covering member being selectively coupled to the cover and at least partially over the hole to restrict a flow of emitted scent from the scent emitting material.

18. The scent emitting writing instrument of claim 17, wherein the covering member is a re-adhering substrate.

19. A scent emitting writing kit comprising:
an elongate housing having an interior and an elongate access slit for accessing the interior;
a substrate that is placed in the interior of the housing and extendable through the elongate slit;
a writing cartridge removably insertable into an end of the housing and at least partially extendable from the housing to permit a user to write; and
a scent cartridge having an interior for receiving a scent emitting material, the scent cartridge being operatively disposed to a portion of the housing.

20. The scent emitting writing instrument of claim 19, further comprising a tether operatively coupled to the scent cartridge to permit hanging of the housing, substrate, writing cartridge and scent cartridge.
